(19) United States
(12) Patent Application Publication
(10) Pub. No.: US 2013/0093562 A1
(43) Pub. Date: Apr. 18, 2013

(54) POWER DISCONNECTING DEVICE

(71) Applicant: ROBERT BOSCH GMBH, Stuttgart (DE)

(72) Inventors: Juergen MACK, Goeppingen (DE); Thomas HEINRICH, Nellmersbach (DE)

(73) Assignee: ROBERT BOSCH GMBH, Stuttgart (DE)

(21) Appl. No.: 13/653,672

(22) Filed: Oct. 17, 2012

(30) Foreign Application Priority Data
Oct. 17, 2011 (DE) 10 2011 084 593.3

(51) Int. Cl. H01H 37/76; H01H 37/74

(52) U.S. Cl. 337/401; 337/298

(57) ABSTRACT

A power disconnecting device includes: two electrical contacts which are electrically conductively connected to one another via a conductor in a closed state of the conductor; and a holding unit which holds the conductor in the closed state, the conductor being pre-tensioned in the direction of an open position, the two electrical contacts not being electrically conductively connected via the conductor in the open position of the conductor. The holding unit has a thermosensitive element, and a heating element is assigned to thermosensitive element. The thermosensitive element changes its shape upon activation of the heating element, thus resulting in the conductor moving into the open position.

### BACKGROUND OF THE INVENTION

1. Field of the Invention

The present invention relates to a power disconnecting device, an electric charging unit, and a battery pack.

2. Description of the Related Art

Different power disconnecting devices, which interrupt the power upon recognition of an error, are known from the related art. For example, temperature fuses, safety fuses, or fuses made of bimetal are used. The known fuses have the disadvantage that they only have a low current carrying capacity or a low electric strength.

### BRIEF SUMMARY OF THE INVENTION

An object of the present invention is to provide a simply and cost-effectively constructed power disconnecting device which has a high current carrying capacity or a high electric strength.

The power disconnecting device according to the present invention has the advantage that the power disconnecting device is constructed in a simple manner and works reliably. This is achieved by providing a movable conductor between two electrical contacts, the conductor electrically conductively connecting the two electrical contacts to one another in its closed state. The conductor is pre-tensioned toward an open position, the two electrical contacts being electrically disconnected in the open position of the conductor. In addition, a holding means having a thermosensitive element is provided, a heating element being assigned to the element. By activating the heating element, the element is changed in such a way that the conductor moves into the open position.

In another specific embodiment, the thermosensitive element is designed in such a way that the element is at least destroyed upon activation of the heating element. In this way, a reliable opening of the electrical connection is achieved between the two contacts. In addition, it is ensured that the two electrical contacts are irreversibly disconnected.

In another specific embodiment, the thermosensitive element may be formed from plastic, wax, or a small tube filled with a liquid, for example, the small tube bursting at a certain temperature. Simple and cost-effective implementations of the element are thus possible.

In another specific embodiment, the element is designed in such away that the element at least bends upon activation of the heating element, thus allowing the conductor to move into the open position. This specific embodiment also makes a reliable and cost-effective power disconnecting device available. Depending on the selected specific embodiment, the element may have taperings or target bending points to ensure an exactly defined deployment behavior. In addition, a recess with which the element engages may preferably be provided in a housing wall. In this way, a robust mechanical construction is provided which is protected against mechanical shocks and vibrations.

In another specific embodiment, the conductor is designed as a pre-tensioned strip, in particular a stable metal strip, one end of the strip being held at the assigned contact with the aid of the element. By using the pre-tensioned strip, a simple implementation of the conductor is possible; if the element is activated, the pre-tensioned strip jumps from its closed position into the open position. This results in the electrically conductive connection between the two contacts being interrupted.

In another specific embodiment, the element is designed as a soldered connection which holds the conductor at the contact. The soldered connection is cost-effective and is manufacturable in a simple manner. In addition, the soldered connection is a reliable way of securing the end of the strip at the assigned contact . Simply by heating up the soldered connection, the solder liquefies and the pre-tensioned strip is able to jump into its open position.

In another specific embodiment, the element is designed as an adhesive bond, the glue used being preferably electrically conductive and temperature-sensitive. The glue is designed in such a way that the glue is liquefied when the glue is heated up. Thus, simply by heating up the glue, the secured end of the conductor may be detached, so that the conductor jumps into the open position.

In another specific embodiment, the heating element is situated on a side of a substrate situated opposite the contact, a temperature bridge being situated between the heating element and the thermosensitive element substrate. Thus, a space-saving construction is made possible, so that on the top side, on which the electrical conductor is situated, no space is needed for the heating element.

In another specific embodiment, the heating element is situated in the substrate and adjacently to the element. In this way, a compact construction of the power disconnecting device is made possible.

In another specific embodiment, the heating element is thermally conductively connected to the element via a thermally conductive channel. It is thus not necessary for the heating element to be close to the element. This allows for increased flexibility when constructing the power disconnecting device.

In another specific embodiment, the heating element is switched electrically in series with a contact. Thus, the power disconnecting device is used for delimiting excess current. Based on this configuration, a separate activation of the heating element is not necessary.

In another specific embodiment, the element maybe formed from an insulating material which is thermally liquefiable. Thermal adhesives are suitable for this purpose, for example. The thermally liquefiable element may be configured in such a way that the element cools down again and electrically insulates the contact after the element has melted and the conductor has moved into the open position.

The power disconnecting device may advantageously also be used in a charging unit and in a battery pack.

### BRIEF DESCRIPTION OF THE DRAWINGS

FIG. 1 shows a power disconnecting device in the closed state.

FIG. 2 shows a power disconnecting device in the open state.

FIG. 3 shows a second specific embodiment of a power disconnecting device.

FIG. 4 shows a power disconnecting device which is situated on a substrate.

FIG. 5 shows the power disconnecting device of FIG. 4 in the open state.

FIG. 6 shows another specific embodiment of a power disconnecting device.

FIG. 7 shows the power disconnecting device of FIG. 6 in the open state.

### DETAILED DESCRIPTION OF THE INVENTION

The present invention relates to a power disconnecting device which may be irreversibly designed, in particular. The power disconnecting device preferably has a high current carrying capacity or electric strength. In addition, the power disconnecting device may be activated or deployed externally in the case of a malfunction of the circuit. Depending on the selected specific embodiment, the power disconnecting device may also be switched in series with the circuit. With the aid of the described power disconnecting device, the circuit is interrupted reliably, effectively, and preferably permanently after a one-time activation of the power disconnecting device. In addition, the power disconnecting device is cost-optimized on the basis of the proposed specific embodiments and needs less space.

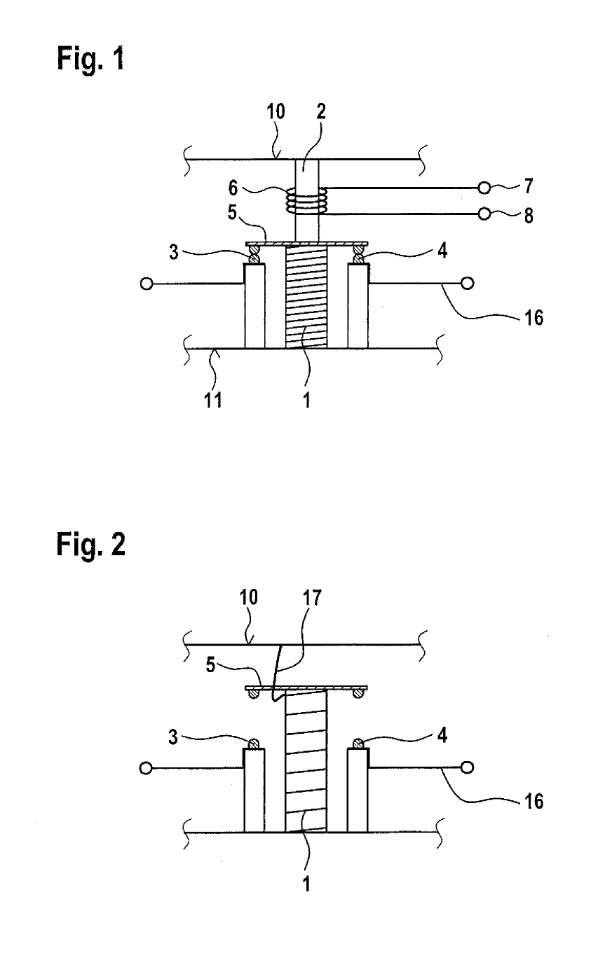

FIG. 1 shows the construction of the power disconnecting device in principle. The power disconnecting device has two electrical contacts 3, 4 which are electrically conductively connected to one another in the illustrated position via conductor 5. Contacts 3, 4 are situated in a line 16 of a circuit. Conductor 5 is designed as a contact plate, for example, and is movable between a spring 1 and an element 2. Element 2 is supported against a first contact area 10 and spring 1 is supported against a second contact area 11. The conductor is in contact with contacts 3, 4 and provides the electrically conductive connection between the contacts. In addition, element 2 is provided with a heating element 6 which is supplied with current via terminals 7, 8. Terminals 7, 8 are connected to a control unit (not illustrated). Element 2 is made from a thermosensitive material which changes its shape when heated to a certain temperature by the heating element and gives in to the pre-tensioning force of spring 1, so that the counterforce of the spring can no longer be absorbed, thus moving conductor 5 in the direction of first contact area 10, thereby opening the electrically conductive connection between the two contacts 3, 4.

FIG. 2 shows the power disconnecting device in the open state. In another specific embodiment, the configuration may be equipped with barbed hooks 17 to prevent conductor 5 from moving back into the closed position. If conductor 5 is pushed away during a deployment of the power disconnecting device, barbed hooks 17, which are additionally situated laterally on conductor 5, prevent the contact plate from detaching and thus first and second contacts 3, 4 from being electrically reconnected. Barbed hooks 17 are thus provided on both conductor 5 and on first contact area 10.

Suitable material to be used for element 2 may, for example, be a type of plastic or waxes. Element 2 is designed in such a way that, when heated to an appropriate temperature, it may become soft, liquefy, or lose its solidity. In addition, a small glass tube filled with a liquid may also be used as material for element 2, the liquid being designed in such a way that it expands, when heated, to the extent that the small glass tube bursts at a certain limiting temperature.

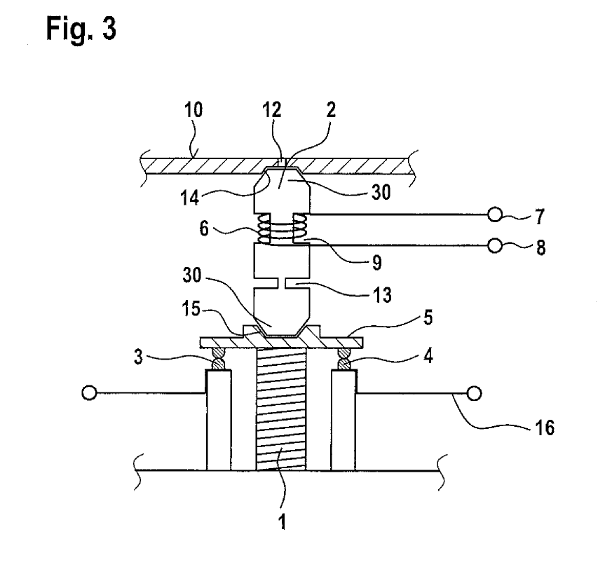

FIG. 3 shows another specific embodiment of the power disconnecting device, element 2 having tapered sections 9 in which element 2 having the shape of a rod has a smaller diameter. Heating element 6 is situated in tapered section 9. Heating element 6 may, for example, have a heater coil which is wound around element 2. By using the heater coil, the heating element may be produced simply and cost-effectively. Now, if heating element 6 is acted on by sufficient current, rod-shaped element 2 is deformed to the extent that it bends at the tapering, i.e. , at tapered section 9, due to the counterforce of spring 1. Rod-shaped element 2 shortens due to the bending, and conductor 5 is shifted in the direction of the first contact area. In this specific embodiment, an opening of electrical contacts 3, 4 is thus also achieved when element 2 is heated.

In the illustrated exemplary embodiment, first contact area 10 is designed as a housing wall and has an inspection window 12. Inspection window 12 is situated in such a way that the open or closed positions of conductor 5 may be checked visually.

Depending on the selected specific embodiment, element 2 may be equipped with additional taperings and/or target bending points to ensure an exactly defined deployment behavior or to enable bending at certain points. In the illustrated exemplary embodiment, element 2 has another tapering 13 in addition to tapered section 9. Furthermore, it may prove advantageous if rod-shaped element 2 is mechanically inserted into a recess 14 of first contact area 10 or into a second recess 15 of conductor 5 by a phase or a cone 30. This construction allows the power disconnecting device to be more robust against vibrations and shocks, since the spring deflection is always offset when the contact is closed. Furthermore, the installation of element 2 is simplified by the phases or cone 30.

When using inspection window 12, it may be advantageous that conductor 5, which is designed as a contact plate, for example, has a mark based on which it maybe recognized rapidly and reliably whether conductor 5 is in the open or the closed position.

Preferably, inspection window 12 may be situated in the area of a front side of element 2, as illustrated. In this way, element 2 pushes visibly against inspection window 12 when conductor 5 is in the closed state. Now, if the power disconnecting device is deployed, it is no longer possible to push element 2 into the recess of inspection window 12 due to its bending. It is thus possible to recognize the open position of the power disconnecting device in a simple manner. Furthermore, this may also be signaled by a pestle, a small bolt, for example, on which element 2 is situated and which protrudes into the inspection window when element 2 is in the closed state. After the deployment of the power disconnecting device and the bending of element 2 associated therewith, the pestle changes its position and is no longer visible in the inspection window from the outside.

Depending on the selected specific embodiment, the power disconnecting device is also used for delimiting excess current. For this purpose, first and second terminals 7, 8 of heating element 6 are switched in series with electrical line 16 which leads to second contact 4, for example. Therefore, the current flowing through the second contact also heats up heating element 6 and consequently also element 2. Due to the thermal time constant or the heat capacity of element 2 and heating element 6, the heating is transferred to element 2 under a certain delay and damping. Thus, temporary current raises do not result in reaching the temperature necessary to deform element 2. The deployment temperature is thus not reached until a continuous, excessively high current through the second contact and the heater coil is achieved.

In another specific embodiment, element 2 is implemented in such a way that after element 2 has melted and subsequently cooled down, conductor 5 is surrounded by the cooled-down material of element 2 at least partially and is electrically insulated. This effect may be additionally improved by providing additional, electrically insulating elements, which melt at a certain temperature, made of wax or plastic, for example. Preferably, conductor 5 is electrically insulated by the melting material in the area of at least one end which faces contacts 3, 4. In this way, re-closure of the electrical connection between the two contacts 3, 4 is prevented by conductor 5. Preferably, the melting elements are situated in the area of the ends at conductor 5.

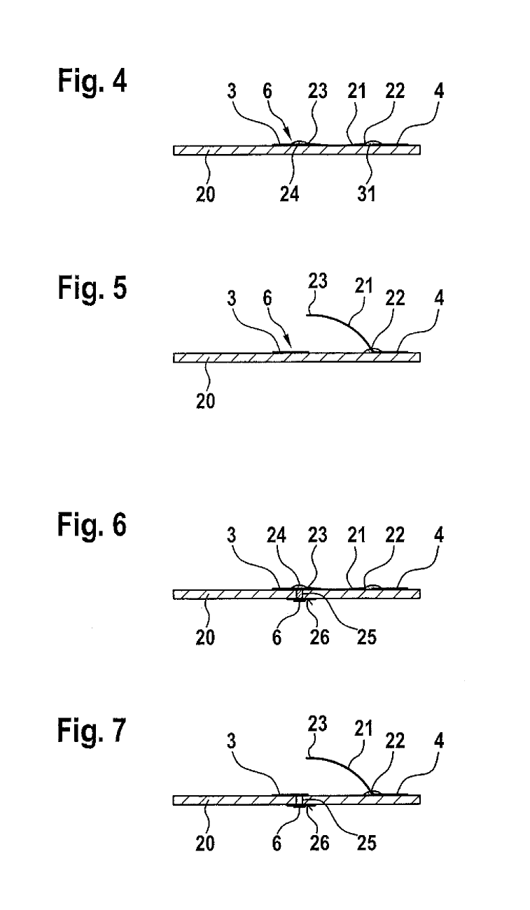

FIGS. 4 through 7 show further specific embodiments of a power disconnecting device which is situated on a substrate 20 and has a pre-tensioned electrically conductive strip 21 as the element. Strip 21 is mechanically pre-tensioned in the closed position in the direction of the open position. In the simplest case, the strip may be a metal strip. Strip 21 is illustrated in FIG. 4 in the closed position and its two ends are electrically conductively connected to a first and a second contact 3, 4. In the illustrated exemplary embodiment, a first end 22 of strip 21 is electrically conductively and mechanically connected to second contact 4 via a solder 31, for example. In addition, a second end 23 of strip 21 is electrically conductively connected to first contact 3 via a melting material 24 on substrate 20. A heating element 6, which is also situated on substrate 20 in the illustrated specific embodiment, is assigned to melting material 24. In the illustrated exemplary embodiment, heating element 6 is situated electrically in series to first contact 3 and is designed in the form of a heater coil, for example. In addition, heating element 6 may, for example, be designed as an electrical resistor, as a resistance wire or as an electric coil. Now, if a sufficiently high current flow is guided via first contact 3, heating element 6, strip 21, and second contact 4, heating element 6 heats up melting material 24. For this purpose, heating element 6 is situated as the thermal operative connection with melting material 24. Now, if melting material 24 is liquefied, strip 21 springs from the closed position illustrated in FIG. 4 to the open position illustrated in FIG. 5. The electrically conductive connection between first and second contacts 3, 4 is thus interrupted.

A solder or a thermally conductive glue, or a meltable plastic may, for example, be used as melting material 24. Depending on the selected specific embodiment, melting material 24 may additionally be designed to be electrically conductive, e.g., in the form of an electrically conductive hot melt adhesive or plastic.

FIG. 6 shows a power disconnecting system which is constructed according to FIG. 4; however, heating element 6 is situated on a bottom side of substrate 20 in contrast to the design of FIG. 4. In this exemplary embodiment, heating element 6 is also situated in series between strip 21 and first contact 3 or between melting material 24 and first contact 3. Here, heating element 6 is thermally coupled to melting material 24 via thermally conductive connecting channels 25. For this purpose, connecting channels 25 are guided from the bottom side to the top side of substrate 20. Depending on the selected specific embodiment, it is also possible that only one connecting channel 25 is provided. The connecting channels are filled with a thermally conductive material, e.g., a solder.

Furthermore, heating element 6 may be situated in the substrate in such a way that it adjoins melting material 24 depending on the selected specific embodiment.

In another specific embodiment, an electrically conductive surface area 26, in particular a copper surface area, is implemented on the bottom side of substrate 20. Conductive surface area 26 is thermally connected to melting material 24 via at least one connecting channel 25.

Depending on the selected specific embodiment, it is possible that heating element 6 from FIGS. 4 through 7 is not connected in series to first contact 3 and is supplied with current via separate terminals.

FIG. 7 shows the power disconnecting device of FIG. 6 in the open state. The described power disconnecting devices are preferably suitable for use in an electric charging unit, in particular in a charging unit for portable power tools. For this purpose, each individual cell of a battery pack of the power tool may be assigned to a corresponding power disconnecting device.

Thus, the described power disconnecting device is suitable for use in a battery pack which is used to supply portable power tools with current.

What is claimed is:

1. A power disconnecting device, comprising:
two electrical contacts electrically conductively connected to one another via a conductor in a closed state of the conductor;
a thermosensitive element which keeps the conductor in the closed state, wherein the conductor is pre-tensioned in the direction of an open position, and wherein the two electrical contacts are not electrically conductively connected via the conductor in the open position of the conductor; and
a heating element assigned to the thermosensitive element, wherein, upon activation of the heating element, at least one of solidity and shape of the thermosensitive element changes to allow the conductor to move into the open position.

2. The power disconnecting device as recited in claim 1, wherein the thermosensitive element becomes at least soft upon activation of the heating element and is at least bent, and allows the conductor to move into the open position.

3. The power disconnecting device as recited in claim 2, wherein the thermosensitive element is one of a plastic element, a wax element, a glass tube filled with a liquid, or a solder element.

4. The power disconnecting device as recited in claim 1, wherein the thermosensitive element is configured to be destroyed upon activation of the heating element.

5. The power disconnecting device as recited in claim 1, wherein the conductor is in the form of a pre-tensioned, bistable metal strip, and wherein one end of the conductor is held at an assigned one of the two contacts with the aid of the thermosensitive element .

6. The power disconnecting device as recited in claim 5, wherein the thermosensitive element is a soldered connection which holds the conductor at the assigned contact, and wherein the heating element is in operative connection with the soldered connection.

7. The power disconnecting device as recited in claim 5, wherein the thermosensitive element is a thermal adhesive bond which is electrically conductive and holds the conductor at the assigned contact, and wherein the heating element is in operative connection with the thermal adhesive bond.

8. The power disconnecting device as recited in claim 2, wherein the heating element is situated on a side of a substrate which is situated opposite the thermosensitive element.

9. The power disconnecting device as recited in claim 5, wherein the assigned contact is applied to a substrate, and the heating element is situated on the substrate and adjacently to the thermosensitive element.

10. The power disconnecting device as recited in claim 8, wherein the heating element is in thermal operative connection with the thermosensitive element via a thermally conductive channel made of one of a solder material or an adhesive material.

11. The power disconnecting device as recited in claim 8, wherein the heating element is switched electrically in series with at least one of the two electrical contacts.

12. The power disconnecting device as recited in claim 8, wherein the heating element is an electrically conductive coil.

13. The power disconnecting device as recited in claim 2, wherein:
the thermosensitive element is configured to melt upon activation of the heating element;
the thermosensitive element is situated in such a way that the melted thermosensitive element flows at least partially in an area of the conductor which is assigned to one of the two contacts; and
after cooling down, the cooled-down thermosensitive element insulates the conductor against an electrically conductive connection with the assigned contact.

14. The power disconnecting device as recited in claim 2, wherein the power disconnecting device is part of an electric charging unit for a portable power tool.

15. The power disconnecting device as recited in claim 2, wherein the power disconnecting device is part of a battery pack.
